(19) United States
(12) Patent Application Publication
(10) Pub. No.: US 2009/0315209 A1
(43) Pub. Date: Dec. 24, 2009

(54) Polypropylene/soy-protein compositions of bio-composite materials, bio-composite sheet using that and preparing method thereof

(75) Inventors: Kie Youn Jeong, Gyeonggi-do (KR); Chae Hwan Hong, Gyeonggy-do (KR); Seong Hoon Lee, Ulsan (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/283,458

(22) Filed: Sep. 11, 2008

(30) Foreign Application Priority Data
Jun. 19, 2008 (KR) 10-2008-0057799

(51) Int. Cl. B29C 51/02; C08L 89/00

(52) U.S. Cl. 264/210.2; 524/25

(57) ABSTRACT

The present invention relates to polypropylene/soybean protein composition for a bio-composite material for an automotive interior or exterior material, a bio-composite sheet prepared by using the composition and its preparation method, and particularly relates to composition for a bio-composite material comprising polypropylene resin, soy protein particles and ZnSO₄. The bio-composite sheet prepared by using the composite material composition is light in weight and superior in strength, elasticity in bending, moldability and price competitiveness. This is pleasant to the touch and also eco-friendly because it can be recycled into other applications through some recycling processes.

### CROSS-REFERENCE TO RELATED APPLICATION

This application claims under 35 U.S.C. §119(a) the benefit of Korean Patent Application No. 10-2008-0057799 filed Jun. 19, 2008, the entire contents of which are incorporated herein by reference.

### BACKGROUND

(a) Technical Field

The present invention relates to polypropylene/soybean protein composition for a bio-composite material for an automotive interior or exterior material, a bio-composite sheet prepared by using the composition and its preparation method.

(b) Background Art

Various materials are widely used for interior materials for building construction or automotive interior or exterior materials such as door trim, a trunk and a bonnet. Examples of such materials include synthetic resin sheets; composite sheets prepared by thermo-pressing and molding synthetic resins, wood/lumber products or side products (e.g., wood chips and sawdust) and binders; and composite sheets prepared by compounding synthetic resins and inorganic particles such as talc.

The synthetic resin sheets are prepared using, for example, melamine resins, polypropylene (PP) resins, poly(vinyl chloride) (PVC) resins, acryl resins and phenol resins. The manufacture of such synthetic resin sheets involves environmental pollution, and the sheets are hard to be recycled and are not eco-friendly.

Wood/lumber products or side products such as wood chips and sawdust have been used for the manufacture of the conventional composite sheets. However, resources of the wood/lumber products and side products are limited. Also, it oftentimes requires large-scale felling operation to obtain the materials for producing such products. Lumber resources are being exhausted due to indiscriminate felling because it takes dozens of years to recover forests, and self-purification power such as oxygen supply is being lowered, thus causing serious environmental problems.

There is thus a need for eco-friendly composite materials for an automotive interior or exterior material that can replace such synthetic resin sheets and composite sheets.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a composition for a bio-composite material for use as interior and exterior material for a vehicle, which comprises a polypropylene resin, soybean protein particles and zinc sulfate.

In a preferred embodiment, the composition comprises 65-85 wt % of a polypropylene resin, 10-30 wt % of soybean protein particles and 2-10 wt % of zinc sulfate are included in the composition.

In another aspect, the present invention provides a process of preparing a polypropylene/soybean protein bio-composite sheet. The process may comprise: mixing the above-described compositions; molding a pallet by extruding the mixed composition; molding a sheet by thermo-pressing the molded pellet at 150-250° C. and 45-80 kg/cm²; and cold-pressing the molded sheet.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows a rear package tray prepared in Preparation Example 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

The compositions for a bio-composite material for an automotive interior or exterior material according to the present invention comprise a polypropylene resin, soybean protein particles and zinc sulfate (ZnSO₄).

The composition according to an embodiment of the present invention comprises 65-85 wt % of a polypropylene resin, 10-30 wt % of soybean protein particles and 2-10 wt % of zinc sulfate (ZnSO₄).

The polypropylene resin (‘PP resin’ hereinafter) is advantageous in abundance in low-priced raw materials, simple preparation, low density, superior mechanical or rheological properties (strength, elasticity and thermosetting property), high thermal conductivity (heat-retaining property), waterproof property and chemical resistance, thus widening its application. PP chips can be used as the PP resin in the present invention.

The PP resin is one or more selected from the group consisting of polypropylene homo polymer, polypropylene random copolymer and polypropylene block copolymer. The melt index (MI) of the PP resin can be 0.5-30 g/10 min, preferably 1.5-20 g/10 min (ASTM D1238, 230° C.). When the melt index is lower than 0.5 g/10 min, the processability of composite material can be deteriorated due to excessive increase in melt viscosity. When the melt index is higher than 30 g/10 min, the improvement of mechanical properties can be limited, thus lowering the industrial applicability.

Suitably, the average molecular weight of PP resin can be 300,000-500,000 g/mol. When the average molecular weight is lower than 300,000 g/mol, properties of the final composite material can be deteriorated. When the molecular weight is higher than 500,000 g/mol, the pressure caused during extrusion can remarkably increase.

The PP resin may be used in the amount of 65-85 wt %, preferably 70-80 wt %, relative to the total weight of the composition. When the amount is less than 65 wt %, the mechanical properties can be deteriorated due to the insufficient amount of polypropylene resin. When the amount is more than 85 wt %, the relative amount of soybean protein particles and zinc sulfate (ZnSO₄) particles can decrease, thus lowering the mechanical properties of bio-composite material.

Soybean protein particles are dispersed in PP resin and improve the properties. Soybean protein can be processed into the following materials. Soybean oil is produced at the first stage, and the residue without containing oil is called defatted soy flake. Soy flour, soy concentrate (‘SC’ hereinafter) and soy protein isolate (‘SPI’ hereinafter) can be obtained from this defatted soy flake.

The protein content of the SC is about 60% or more and that of the SPI is 90% or more, and the SC and SPI contain hydrocarbons. A mixture of the SC and SPI, pulverized into an average diameter of 5-50 μm, preferably 10-30 μm, can be used as soybean protein particles in the present invention. When the average diameter of soybean protein particles is lower than 5 μm, coagulation can be caused in PP resin due to decrease in dispersibility, thus lowering properties. When the average diameter is higher than 50 μm, impact properties can be deteriorated, thus limiting industrial applicability.

Soybean protein particles may be used in the amount of 10-30 wt %, preferably 15-25 wt % relative to the total weight of the composition. When the amount is less than 10 wt %, mechanical properties may be deteriorated, thus lowering industrial applicability. When the amount is higher than 30 wt %, the production cost may increase, thus also lowering industrial applicability.

Zinc sulfate cross-links micrometer-sized soybean protein particles dispersed in a PP resin. Zinc sulfate may be used in the amount of 2-10 wt %, preferably 3-5 wt % relative to the total weight of the composition for bio-composite material. When the amount is less than 2 wt %, the degree of cross-linking of soybean protein particles dispersed in PP resin can be lowered, thus deteriorating impact strength.

When the amount is higher than 10 wt %, he pressure caused during extrusion can remarkably increase due to excessive cross-linkage between soy particles.

The aforementioned bio-composite material can be used for the manufacture of a bio-composite sheet for an automotive interior or exterior material. Hereunder is provided a detailed description of a method of preparing bio-composite sheet of the present invention.

A method of preparing a polypropylene/soybean protein bio-composite sheet according to the present invention comprises the steps of (a) mixing the composition for bio-composite material; (b) molding pallets by extruding the mixed bio-composite material; (c) molding a sheet by thermo-pressing the molded pellet at 150-250° C. and 45-80 kg/cm²; and (d) cold-pressing the molded sheet to prepare the bio-composite sheet.

In the step (a), the bio-composite material comprises 65-85 wt % of a PP resin, 10-30 wt % of soybean protein particles and 2-10 wt % of zinc sulfate (ZnSO₄). These are completely mixed by using a mixing machine (a blending machine or a hopper). The aforementioned PP resin, soybean protein particles and zinc sulfate can also be used here.

In the step (b), the extrusion can be conducted as well known in the art without limitation. For example, the mixed materials may be molded into pellets by using a biaxial extruder.

In the step (c), the molded pellets are thermo-pressed into a sheet at 150-250° C. and 45-80 kg/cm², preferably 50-70 kg/cm². When temperature is lower than 150° C., it can become difficult to mold the pellets due to the supply of insufficient heat. Temperature of higher than 250° C. can cause deformation of and odor. When pressure is lower than 45 kg/cm², the degree of denseness in composite material can be insufficient. When pressure is higher than 80 kg/cm², the surface roughness can increase due to excessive pressure.

In the step (d), the molded sheet is cold-pressed into a bio-composite sheet having a particular shape. The molded sheet extruded in the step (c) is rapidly cooled, thus strengthening the structure and smoothing the surface of the bio-composite sheet. Preferably, the resultant bio-composite sheet has a thickness of 1.5-4.5 mm, more preferably 2-3 mm. A thicker sheet can also be prepared and used depending on its application.

Thus-prepared polypropylene/soybean protein bio-composite sheet is light in weight and eco-friendly, and also superior in waterproof property, strength, elasticity in bending, moldability and price-competitiveness, thus being applicable to automotive interior or exterior materials such as a dash outer, a dash inner, a hood silence, a door pad, a door trim, a headliner, a package tray, a trunk mat and a rear package tray.

As one of main ingredients of the bio-composite sheet, soybean protein particles can be considered as eco-friendly because soy is widely being cultivated worldwide and grows rapidly with superior environment adaptability. Further, the bio-composite according to the present invention can be advantageously recycled for the manufacture of panels after it is cut and thermo-pressed. A process of preparing a bio-composite sheet according to the present invention is superior in quality- and price-competitiveness because it comprises relatively small number of steps and can be easily applicable to mass production with high productivity.

The aforementioned polypropylene/soybean protein bio-composite material and a bio-composite sheet prepared by using the bio-composite material can have different thickness and strength depending on its application such as building industry.

### EXAMPLES

The following examples illustrate the invention and are not intended to limit the same.

### Preparation of Polypropylene/Soybean Protein Bio-Composite Sheet

### Examples 1-8

A polypropylene/soybean protein composition for a bio-composite material was prepared by completely mixing polypropylene random copolymer resin with melt index 20 g/10 min (ASTM D1238, 230° C.) (R724J, LG-Caltex, Korea), soybean protein particles with average particle size of 25 μm (Supro 760, Protein Technologies, U.S.) and zinc sulfate (Aldrich, U.S.) as shown in Table 1 using a mixing machine. Pell ets were molded by extruding the composition using a biaxial extruder at 210° C. (higher than the melting point). A sheet was prepared by thermo-pressing the pellet at 210° C. and 68 kg/cm², and the molded sheet was cold-pressed, thus providing the polypropylene/soybean protein bio-composite sheet (Examples 1-4).

Examples 5-6 were conducted as described in Examples 1-4 except that polypropylene random copolymer resin having a melt index 8 g/10 min (ASTM D1238, 230° C.) and melt index 30 g/10 min were used, respectively.

Examples 7-8 were conducted as described in Examples 1-4 except that soybean protein particles having an average diameter of 10 μm and 45 μm were used, respectively.

### Comparative Examples 1-4

Comparative Examples 1-2 were conducted as described in Examples 1-4 except that the amounts of ingredients were outside the range according to the present invention as shown in Table 1.

Comparative Example 3 was conducted as described in Examples 1-4 except that polypropylene random copolymer resin having a melt index of 40 g/10 min was used.

Comparative Example 4 was conducted as described in Examples 1-4 except that soybean protein particles having an average diameter of 65 μm were used.

TABLE 1

| | | | soybean | |
|---|---|---|---|---|
| | | | protein | |
| | | PP resin | particles | zinc sulfate |
| Examples | 1 | 70 | 25 | 5 |
| | 2 | 75 | 20 | 5 |
| | 3 | 80 | 15 | 5 |
| | 4 | 85 | 12 | 3 |
| | 5 | 75 | 20 | 5 |
| | 6 | 75 | 20 | 5 |
| | 7 | 75 | 20 | 5 |
| | 8 | 75 | 20 | 5 |
| Comparative | 1 | 62 | 30 | 8 |
| Examples | 2 | 90 | 5 | 5 |
| | 3 | 75 | 20 | 5 |
| | 4 | 75 | 20 | 5 |

### Test Examples

Measurement of Properties

For the measurement of mechanical properties of bio-composite sheets prepared in Examples 1-8 and Comparative Examples 1-4, specimens were prepared by injection molding, followed by the measurement of the properties, as described in ASTM D 638, ASTM D 256 and ASTM D 790. The results are presented in Table 2. Specimens for measurement of tensile properties have dumbbell-like shape. Specimens for measurement of impact properties have notches.

Measurement of Tensile Properties

Specimens were prepared and tensile strength was measured according to ASTM D 638 (Standard Test Method for Tensile Properties of Plastics) by using a UTM (Universal Testing Machine) and the following formula.

Tensile strength (Pa)=Maximum load (load, N)÷Initial cross-sectional area of specimens (m²) Formula 1

Measurement of Impact Strength

Specimens were prepared and impact strength was measured according to ASTM D 256 by using an Izod impact tester.

Measurement of Flexural Modulus

Specimens were prepared and flexural modulus was measured according to ASTM D 790 by using a UTM (Universal Testing Machine).

TABLE 2

| | Results | | |
|---|---|---|---|
| | Tensile | Impact | Flexural |
| | strength | strength | modulus |
| | (kgf/cm²) | (kgf-cm/cm) | (kgf/cm²) |
| Example 1 | 244 | 9.3 | 16550 |
| Example 2 | 248 | 9.2 | 16500 |
| Example 3 | 250 | 9.0 | 16380 |
| Example 4 | 260 | 8.7 | 16420 |
| Example 5 | 251 | 9.1 | 16600 |
| Example 6 | 243 | 9.1 | 16400 |
| Example 7 | 248 | 9.2 | 16520 |
| Example 8 | 249 | 8.9 | 16450 |
| Comparative | 222 | 4.3 | 16100 |
| Examples 1 | | | |
| Comparative | 204 | 5.9 | 15900 |
| Examples 2 | | | |
| Comparative | 259 | 3.9 | 16200 |
| Examples 3 | | | |
| Comparative | 215 | 4.1 | 16000 |
| Examples 4 | | | |

The results of Examples 1-4 show that tensile strength increases and impact strength decreases as the PP resin content increases and the soy protein particle content decreases. When compared to Example 6, the higher melt index of PP resin as used in Example 5 caused the increase in tensile strength while impact strength was similar. This shows that the melt index of the PP resin is related to tensile strength.

Further, when compared to Example 7, higher particle size of soybean protein particles as used in Examples 8 caused the decrease in impact strength, which shows the correlation between the size of soybean protein particles and impact strength.

Comparative Examples 1-2, where the amounts of ingredients are outside the range according to the present invention, showed lowered tensile strength, impact strength and flexural modulus as compared those in Examples 1-8.

Comparative Example 3, where melt index of 40 g/10 min was higher than 30 g/10 min (ASTM D1238, 230° C.), showed a remarkable decrease in impact strength whereas tensile strength and flexural modulus were satisfactory.

In Comparative Example 4, where the average particle size of soybean protein particles (50 μm) was higher than 65 μm, all the tested properties (tensile strength, impact strength and flexural modulus) were lower than those of Examples.

### Test Example 2

Measurement of Density

Density of bio-composite sheets prepared in Examples 1-8 was measured according to ASTM D792, and the results are presented in Table 3.

TABLE 3

| Classification | Density (g/cm³) |
|---|---|
| Example 1 | 0.99 |
| Example 2 | 0.98 |
| Example 3 | 0.97 |
| Example 4 | 0.96 |
| Example 5 | 0.98 |
| Example 6 | 0.98 |
| Example 7 | 0.98 |
| Example 8 | 0.98 |

Table 3 shows that the bio-composite sheets prepared by using bio-composite material according to the present invention have a density of less than 1, thus ascertaining the lightweight of the bio-composite sheets herein.

### Preparation Example 1

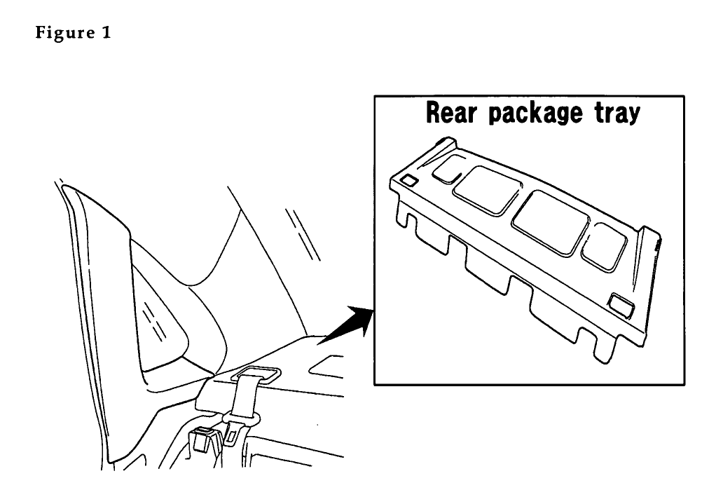

As an example of interior material, a rear package tray was prepared by using the polypropylene/soybean protein bio-composite sheet obtained in Example 1, and FIG. 1 shows the rear package tray provided in a vehicle.

As ascertained in Test Examples 1-2, the bio-composite sheets prepared according to the present invention are light in weight and eco-friendly, and also superior in waterproof property, strength, elasticity in bending, moldability and price-competitiveness, thus being applicable to automotive interior or exterior materials such as a dash outer, a dash inner, a hood silence, a door pad, a door trim, a headliner, a package tray, a trunk mat and a rear package tray.

As discussed above, the bio-composite sheets according the present invention are light in weight, superior in strength, elasticity in bending, moldability and price competitiveness, and pleasant to the touch and also eco-friendly.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A composition for a bio-composite material for use as interior and exterior material for a vehicle, which comprises a polypropylene resin, soybean protein particles and zinc sulfate.

2. The composition of claim 1, wherein 65-85 wt % of a polypropylene resin, 10-30 wt % of soybean protein particles and 2-10 wt % of zinc sulfate are included in the composition.

3. The composition of claim 1, wherein the polypropylene resin has a melt index (MI) of 0.5-30 g/10 min (ASTM D1238, 230° C.) and is one or more selected from the group consisting of polypropylene homo polymer, polypropylene block copolymer and polypropylene random copolymer.

4. The composition of claim 1, wherein the soybean protein particles have an average diameter of 5-50 μm.

5. A process of preparing a polypropylene/soybean protein bio-composite sheet, which comprises the steps of:
(a) mixing the composition for a bio-composite material of claim 1;
(b) molding a pallet by extruding the mixed composition;
(c) molding a sheet by thermo-pressing the molded pellet at 150-250° C. and 45-80 kg/cm²; and
(d) cold-pressing the molded sheet.

6. A process of preparing a polypropylene/soybean protein bio-composite sheet, which comprises the steps of:
(a) mixing the composition for a bio-composite material of claim 2;
(b) molding a pallet by extruding the mixed composition;
(c) molding a sheet by thermo-pressing the molded pellet at 150-250° C. and 45-80 kg/cm²; and
(d) cold-pressing the molded sheet.
